(19) United States
(12) Patent Application Publication
(10) Pub. No.: US 2007/0073901 A1
(43) Pub. Date: Mar. 29, 2007

(54) Sending station and method for operating sending station in communication system

(75) Inventors: Paul Walter Baier, Kaiserslautern (DE); Jochen Hahn, Kaiserslautern (DE); Michael Meurer, Kaiserslautern (DE); Tobias Weber, Rostock (DE); Wolfgang Zirwas, Groebenzell (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/522,430

(22) Filed: Sep. 18, 2006

(30) Foreign Application Priority Data
Sep. 16, 2005 (DE) 10 2005 044 388.5

(51) Int. Cl. G06F 15/16

(52) U.S. Cl. 709/246

(57) ABSTRACT

A sending station forms a send vector from a data vector having N elements by coding with an error correction code with an a-value modulation alphabet and Q elements, with a being a natural number equal to or greater than two, and sends the send vector to user equipment. The send energy able to be used for sending the send vector is distributed to the Q elements taking into consideration at least one characteristic of the error correction code such that the probability of an incorrect decoding of a receive vector received by the user equipment on the basis of the send vector sent is reduced.

### CROSS REFERENCE TO RELATED APPLICATIONS

This application is based on and hereby claims priority to German Application No. 10 2005 044 388.5 filed on Sep. 16, 2005, the contents of which are hereby incorporated by reference.

### BACKGROUND

Resources available for electrical transfer of information are frequency and time. Many transmission channels are characterized in that current channel state determining the transmission quality, described for example by the transmission attenuation and/or the noise effective at the receiver input, depends within the transmission bandwidth used on the frequency and/or within the transmission duration used on the time. Reference is then made to frequency or time selectivity, with the term time variance being more commonly used than the term time selectivity. Frequency selectivity and time variance are to be observed in an especially marked form in radio communication systems.

In many communication systems the current channel state is known on the sender side. This applies for example to the downlink of TDD (Time Division Duplex) communication systems, if a channel estimation is undertaken in the uplink on the base station side, the result of which, because of the reciprocity obtaining, also describes the channel state for the uplink. In FDD (Frequency Division Duplex) radio communication systems knowledge can be obtained on the sender side of the channel state for transmissions to a receiving station by determining the channel state on the receiver side or recording corresponding measured values and notifying them to the sending station, for example over a signaling channel. On the send side there is usually a specific send energy available for sending individual information units, for example individual data vectors. To improve the receive quality on the receive side, that is to reduce the probability of incorrect detection, data vectors are error-corrected on the sender side, for example using what is known as FEC (Forward Error Correction) coding. Furthermore radio communication systems with forward error correction are known, in which an available send energy is distributed on the send side to the elements of the coded data stream, taking into account known channel states of the transmission channels used on the send side, such that the probability of correct decoding is increased on the receiver side. Such a method is described in “Mutti, C., Dahlhaus, C.: “Adaptive Power Loading for Multiple-input Multiple-Output OFDM-Systems with Perfect Channel State Information”, Joint COST 273/284 Workshop on Antennas and Related System Aspects in Wireless Communications, Gothenburg, Sweden, June 2004”.

### SUMMARY

An aspect is to specify an improved method for operation of a sending station as well as a corresponding sending station, by which send energy available on the sender side is distributed to elements of an encoded data stream such that a probability of incorrect decoding is reduced on the receiver side.

In this method for operation of a sending station in a communication system, the sending station forms a data vector having N elements by encoding with an error correction code a send vector with an a-value modulation alphabet and Q elements, whereby a is a natural number equal to or greater than two, and sends the send vector to a receiving station. The send energy available for sending the send vector T is distributed to the Q elements taking account of at least one property of the error correction code such that a probability of an incorrect decoding of a receive vector received by the receiving station on the basis of the sent send vector is reduced.

The inventors have discovered that the probability of an incorrect decoding for a specific distribution of a usable send energy T to the elements of a send vector depends on the error correction code which is used, i.e. the characteristics which an error correction code used has. By utilizing this knowledge, the send energy is distributed in accordance with the Q elements of the send vector depending on the characteristics of the error correction code used such that the probability of an incorrect decoding of the send vector reduces and is even minimized in the ideal case. Both a reduction of the probability of an incorrect decoding in relation to an even distribution of the send energy to all Q elements can be achieved, and also a reduction compared to methods which exclusively use channel states in respect of transmission channels used for transmission of the elements of the send vector for a definition of a send energy distribution.

An embodiment makes provision for a number K of the correctable errors on decoding of the receive vector to be used as the at least one characteristic of the error correction code.

The number K of the correctable errors is a natural number greater than or equal to one.

If, for example, a block code is used as the error correction code which can correct a single error in the send vector regardless of the position of this error, but not more than one error, then this property of the error correction code can be taken into account, for example, in such a way that the element of the send vector confronted with the worst channel state is provided with very little send energy or none at all, since the error correction code can always correct a single error. The available send energy is distributed between the remaining elements of the send vector. For example the send energy is distributed evenly to the remaining elements or the send energy is distributed to the remaining elements using known methods which take account of the channel states in respect of the transmission channels used in each case to send the elements.

Furthermore the number K of the correctable errors of the error correction code can depend on the send vector, i.e. on the arrangement of the Q elements. If a send vector with an a-value modulation alphabet and Q elements is used, there are a^{Q} different quantized receive vectors. Depending on send vector sent (i.e. for a=2, depending on bit sequence) a different number of errors is able to be corrected. Taking account of this different number of correctable errors of the different send vectors on distribution of the send energy to the respective Q elements is part of the scope hereof.

A preferred embodiment makes provision for a radio communication system to be used as the communication system.

In an advantageous manner Orthogonal Frequency Division Multiplex (OFDM) is used for sending the send vector, so that the elements of the send vector will be sent using a carrier frequency in each case.

Different carrier frequencies can of course be used in each case for all elements and also the same carrier frequency can be used for individual elements or all elements of the send vector.

An advantageous development makes provision for the usable send energy to be divided up into different send energy proportions and for a send energy proportion to be distributed in a certain number of iterations to that element of the Q elements for which in the corresponding iteration there is the least probability of an incorrect decoding of the receive vector.

The result of this successive distribution of the send energy proportions to the Q elements of the send vector is that in the last iteration a send vector is formed, which in relation to all other possible distributions of the send energy components to the Q elements, causes the least probability of an incorrect decoding of the receive vector. The probability of an incorrect decoding is minimized by the iterative method for the send energy proportions used.

The sending station has all the features needed for carrying out the method, including execution of the method or method variants.

### BRIEF DESCRIPTION OF THE DRAWINGS

These and other objects and advantages will become more apparent and more readily appreciated from the following description of exemplary embodiments using a two-value modulation alphabet, taken in conjunction with the accompanying drawings of which:

FIG. 1 is a schematic diagram of a radio communication system, having a sending station, a transmission channel and a receiving station, in which the method is carried out, and

FIG. 2 is a Nassi-Shneiderman diagram which describes the typical execution sequence of an iterative method in the radio communication system shown in FIG. 1.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

A sending or receiving station used in the method is for example user equipment or a NodeB of a radio communication system in each case. A sending or a receiving station can of course also be taken to mean stations of a communication system, for example of a data network in which data is transmitted circuit-switched between the stations. Transmission technologies such as OFDM, as used for example in ADSL (Asymmetric DSL), SDSL (Symmetric DSL) or other forms of DSL, can be used for circuit-switches data transmission for example.

User equipment is for example a mobile radio terminal, especially a mobile telephone or also a mobile or fixed device for transmission of image and/or sound data, for fax, Short Message Service (SMS), Multimedia Messaging Service (MMS) and/or e-mail transmission and/or for Internet access.

A NodeB is a network-side radio station which receives user and/or signaling data from user equipment and/or sends user and/or signaling data to the user equipment. A nodeB is connected via network-side devices to a core network, via which connections are made to other radio communication systems in other data networks.

A data network is typically to be seen as the Internet or a fixed network with for example circuit-switched or packet-switched connections for voice and/or data for example.

The following description regards a NodeB base station as a sending station and user equipment as a receiving station, without however wishing to express that the invention is to be restricted to this arrangement. User equipment can also be used as a sending station and a NodeB as a receiving station for example.

The invention can advantageously be used in any communication systems, especially radio communication systems. Radio communication systems are taken to mean systems in which a data transmission between radio stations occurs over a wireless interface. Data transmission can be both bidirectional and also unidirectional. Radio communication systems are especially any mobile radio system for example in accordance with the GSM (Global System for Mobile Communications) or the UMTS (Universal Mobile Telecommunications system) standard. Future mobile radio communication systems, for example of the fourth generation, as well as ad-hoc-networks, are also to be understood as radio communication systems. Radio communication systems are for example also WLANs (Wireless Local Area Networks) in accordance with the IEEE (Institute of Electrical and Electronics Engineers) 802.11a-i, HiperLAN1 and HiperLAN2 standards (HiperLAN: High performance radio local area network) as well as Bluetooth networks and broadband networks with wireless access, for example in accordance with IEEE 802.16.

In the following, a radio communication system is described in which OFDM is used for sending send vectors, without however wishing to express that the invention is to be restricted to this.

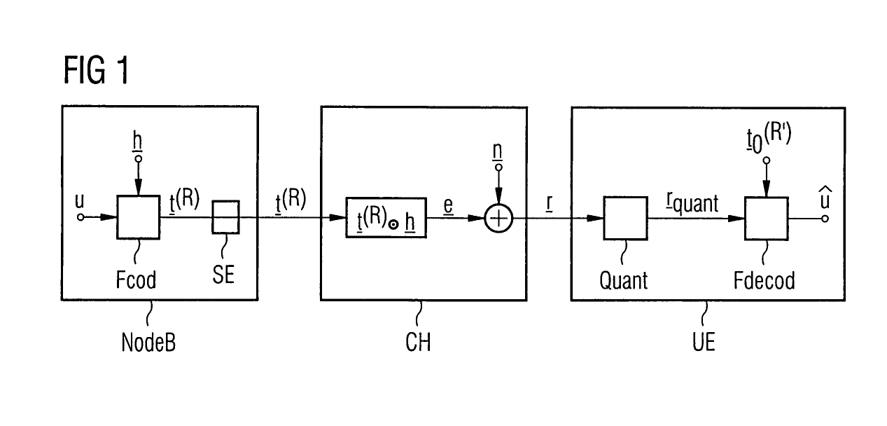

FIG. 1 shows a schematic of a base station NodeB of a radio communication system. The base station NodeB features all devices which are required for operation of a base station in the radio communication system. For reasons of clarity, none of these devices except for an error correction coding unit Fcod are shown in the diagram. In the base station NodeB a data vector u to be transmitted, which has of N elements, is routed to the error protection coding unit Fcod. The following applies:
u=(uₗ . . . u_{N})^{T}, uₙε{−1, 1 }. (1)

Furthermore the error correction coding unit Fcod is supplied with channel coding information h, from which the channel states of at least those carrier frequencies can be taken, on which subsequently a send vector t^{(R)} formed by the base station NodeB by error correction coding of the data vector u will be sent by a send unit SE to user equipment UE. For example each element of the send vector t^{(R)} is sent on an OFDM subcarrier in each case.

The send vector t^{(R)} contains Q elements, and is formed from the data vector u to be sent, taking into consideration the channel state information h=(h₁ . . . h_{Q})^{T} as well as taking into account a number K of errors able to be corrected in the error correction coding unit Fcod by the error correction code used. The error correction code used is for example a block code, a folding code, a turbo code or a space-time code. Furthermore the use of coded modulation is possible, which means that the enlargement of the bandwidth necessary by increasing the modulation alphabet is bypassed, with the attempt always being made to achieve the maximum spacing between the individual code words.

For a data vector of length N with binary values there are 2^{N} different data vectors which can be formed and transmitted. The user equipment UE does not know which data vector u the NodeB is sending. However the system involved is what is known as a receiver-oriented system, in which the user equipment UE, for each transmissible data vector u^{(R)} knows about precisely one coded vector t₀^{(R)}, with R=1 . . . 2^{N}, with Q elements in each case.

The send vector t^{(R)} is transmitted over a channel CH indicated symbolically by a small box. In the transmission a multiplication of the elements t_{q}^{(R)} of the send vector t^{(R)} by the elements h_{q} of the channel state information h, with q=1 . . . Q is undertaken mathematically component-by-component in relation to OFDM. This is shown in the figure by t^{(R)}⊙h. In this way a vector e is produced to which the noise n=(n₁ . . . n_{Q})^{T} present in the relevant transmission channels of the elements is added component-by-component.

In this embodiment a separate carrier frequency (a separate subcarrier) is used for sending the send vector t^{(R)} for each element. Thus a separate transmission channel with channel state information h_{q} exists for each element. Of course the same carrier frequency and thereby the same transmission channel can be used for individual elements or for all elements.

After transmission over a faulty channel CH the user equipment UE receives a receive vector r. When for example a binary modulation alphabet is used, the elements of the receive vector r are no longer exactly −1 or +1 and are thus assigned the values −1 or +1 in a unit Quant. For example an element of which the value is less than 0 is assigned the value −1 whereas an element of which the value is for example equal to or greater than 0 is assigned the value +1. For other modulation alphabets too a quantizing is used in which there is an assignment to the closest possible value of the modulation alphabet. In this way a quantized receive vector r_{quant} is produced from the receive vector This is fed to an error correction decoding unit Fdecod. In the error correction decoding unit Fdecod a correlation of the quantized receive vector r_{quant} with all possible coded vectors t₀^{(R′)} takes place, with R′ passing through the values 1 to 2^{N}. That data vector ûwhich corresponds to the coded vector with greatest correlation value is taken as the result. As well as the quantizing procedure described in which an explicit assignment of the received values to a fixed value is undertaken (“hard-decision” decoding), reliability information can also be taken into account for the decoding in the error correction decoding unit Fdecod (“soft-decision” decoding

The send vector t^{(R)} must thus be selected so that the probability of the detected data vector û not being equal to the sent data vector u is as small as possible. This is synonymous with correlation of the receive vector r_{quant} with t₀^{(R′)} having the maximum value for that value of R′ at which t₀^{(R′)} is assigned to the sent data vector u. If a “soft-decision” decoding is undertaken in the error correction decoding unit Fdecod, its behavior can be anticipated by a suitable choice of t^{(R)}. This method is performed for a send energy with a predetermined value T. The following then applies for the send energy T:
½(t^{(R)})^{T} t^{(R)}=T. (2)

The send energy T is distributed for example taking into account a number K of errors that can be corrected by the error correction code used in the forward error correction unit to the Q elements of the send vector t^{(R)} such that a probability of an incorrect decoding of the receive vector ûis reduced.

The coded vectors t₀^{(R)}assigned to the transmitted data vectors u^{(R)} are used by the user equipment UE and are of course also known in the receiver-oriented system to the NodeB as well.

The application of the described method for determining the send vector for a binary modulation alphabet and real components t_{q} of the send vector is described below. An expansion for components t_{q} of the send vector is then described.

First, the leading signs of the elements of the send vector t^{(R)} are defined as follows:
sign(t_{q}^{(R)}h_{q})=sign(t_{o,q}^{(R)}), q=1 . . . Q . (3)
This is equivalent to
sign(t_{q}^{(R)})=sign(t_{o,q}^{(R)}h_{q}). (4)

Second, the amplitudes of the elements of the send vector t^{(R)} are determined. The variables specified below are needed for this:

For each element of the quantized receive vector r_{quant}=(r_{quant, 1} . . . r_{quant, Q})^{T}, a probability can be specified that the value of the element r_{quant,q} will be unequal to the value of the corresponding element t_{0,q} of the coded vector belonging to the sent data vector. For the qth element of the quantized receive vector r_{quant,q} the following then applies for the probability just mentioned:

$$\begin{matrix}{P}_{q} = Pr \{ {r}_{quant , q} \neq {t}_{o , q} \} \\ = \frac{1}{\sqrt{2 π} {σ}_{n}} {\int }_{- ∞}^{0} exp ( - \frac{{( {n}_{q} - {t}_{q}^{( R )} {h}_{q} {t}_{o , q}^{( R )} )}^{2}}{2 {σ}_{n}^{2}} ) ⅆ {n}_{q} \\ = \frac{1}{2} erfc ( - \frac{\vert {t}_{q}^{( R )} {h}_{q} \vert}{\sqrt{2} {σ}_{n}} ) .\end{matrix} \qquad ( 5 )$$

This probability is referred to as a partial error probability.

Once leading signs of the elements of the send vector t^{(R)} have been determined using formulae (3) or (4), the amplitude of the elements, i.e. the relevant value of the send power is to be calculated. The amplitudes do not depend on which of the 2^{N} possible data vectors will actually be transmitted. The following then thus applies for the value of the individual elements
|t_{q}^{(R)}|=t_{q}≧0,R=1. . . 2^{N}. (6)
Therefore a size variable which specifies the amplitude of the elements of the send vector must be determined:
t=(tₗ . . . t_{Q})^{T}. (7)

Without the invention being restricted to this, it is assumed by way of an example that an error correction code is used which can correct up to K errors regardless of the send vector used and regardless of the position of the error, with K being a natural number equal to or greater than one. In this case the probability of an incorrect data vector being determined is synonymous with the probability that the quantized receive vector r_{quant} contains more than K incorrect elements.

With K and the partial error probabilities from formula (5) the probability of an incorrect detection of the data vector u can be expressed as

$$\begin{matrix}{P}_{w} = {P}_{w} ( {P}_{1} … {P}_{Q} ) \\ = 1 - {\prod }_{q = 1}^{Q} ( 1 - {P}_{q} ) \\ [ 1 + {\sum }_{k = 1}^{K} \underbrace{\{ {\sum }_{{μ}_{1} = 1}^{Q} {L}_{{μ}_{1}} {\sum }_{{μ}_{2} = {μ}_{1} + 1}^{Q} {L}_{{μ}_{2}} … {\sum }_{{μ}_{k} = {μ}_{k - 1} + 1}^{Q} {L}_{{μ}_{k}} \}}_{k Summen} ] ,\end{matrix} \\ with \\ {L}_{q} = \frac{{P}_{q}}{1 - {P}_{q}} . \qquad ( 8 )$$

By resorting on formula (5) and formula (7) P_{w} from formula (8) can be expressed as a function of the size vector from formula (7). The following applies:
P_{w} =P_{w}(tₗ . . . t_{Q})=P_{w}(t). (9)

In accordance with the preferred method, a smallest possible P_{w} is now to be selected in which the amplitude t_{q} of the elements t_{q}^{(R)} of t^{(R)} is suitably selected.

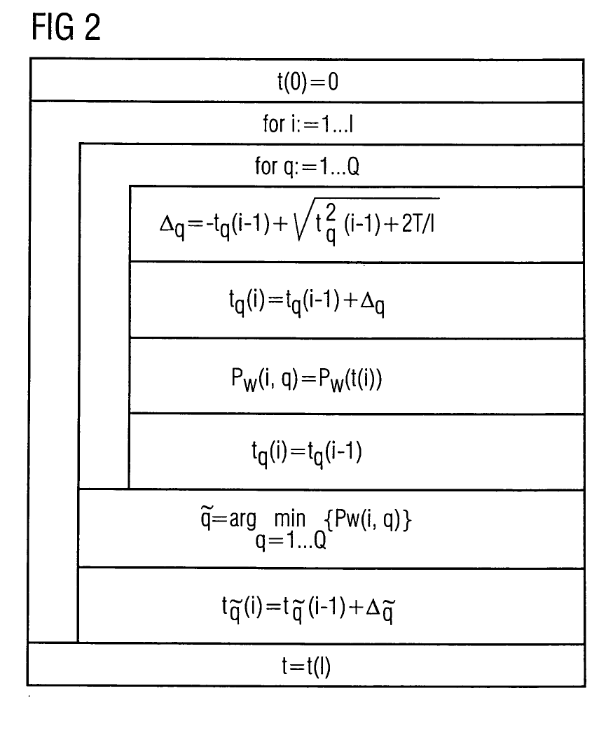

An iterative method for distributing the send energy to achieve a smallest possible error probability is shown in FIG. 2.

Initially all values of the size vector are set to 0.
t(0)=0. (10)

In the first Iteration with I=1 each component t_{q} of the size vector t is assigned a send energy proportion of TII in turn, while the other elements of the size vector each have the value 0 and for each of these size vectors t(I) thus selected, the probability P_{w} is determined in each case that a data vector will be incorrectly decoded. At the end of the first iteration, i.e. if q has assumed the value Q, that q is determined for which the least probability P_{w} has been produced The corresponding component t_{q} is assigned to the send energy proportion TII. In this way the size vector t(1) to be used for the second Iteration is produced. This procedure is repeated iteratively, as shown in the Nassi-Shneiderman diagram, until finally the size vector t(I) is obtained.

This is the size vector t which specifies the amplitudes of the elements of the send vector t^{(R)} to be used, so that when the leading signs of the elements of the send vector t^{(R)} calculated in accordance with formulae (3) or (4) are used, the probability of an incorrectly decoded data vector is as small as possible.

As shown in FIG. 2, the allocation of a send energy proportion TII to t_{q} (I−1) increases this value by
Δ_{q}=−t_{q}(i−1)+\sqrt{t_{q}²(i−1)+2T|I} (11)
This leads to
t_{q} (i)=t_{q} (i−1)+Δ_{q}. (12)

The formulae shown above use values from the set of the real numbers. This typically described example can of course also be extended to channel state information h_{q} and send vectors t_{q}^{(R)} with values from the set of the complex numbers. In this case, instead of the leading sign function in formula (3) or formula (4) the argument function is used,
arg (t_{q}^{(R)})=−t_{o,q}^{(R)} arg (h_{q}) (13)
in order to determine the argument of the complex-value t_{q}^{(R)}.

The method can of course also be executed if, instead of equal-size send energy proportions TII different energy proportions are distributed in the individual iterations to the elements of the send vector. The sum of the distributed send energy proportions is obviously always the equal to the total available send energy T.

The invention is of course not restricted to the exemplary embodiment described with reference to FIGS. 1 and 2. It lies within the scope of the usual knowledge of the person skilled in the art to also take account of other characteristics of an error correction code used to carry out a method for distributing an available send energy to elements of a send vector such that the probability is increased of a receiving station decoding the data vector which was sent.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method for operating a sending station communicating with a receiving station in a communication system, comprising:
encoding a data vector consisting of N elements using an error correction code to form a send vector with an a-value modulation alphabet and Q elements, where a is a natural number greater than one and send energy, able to be used for sending the send vector, is distributed to the Q elements, taking into account at least one characteristic of the error correction code, to reduce a probability of an incorrect decoding by the receiving station of a receive vector corresponding to the send vector; and
sending the send vector to the receiving station.

2. A method as claimed in claim 1, wherein the at least one characteristic of the error correction code includes a number of errors able to be corrected on decoding of the receive vector.

3. A method as claimed in claim 2, wherein a radio communication system is used as the communication system and the send vector is sent over a wireless interface.

4. A method as claimed in claim 3, wherein said sending uses Orthogonal Frequency Division Multiplex to send the send vector, so that the elements of the send vector are sent in each case by a carrier frequency.

5. A method as claimed in claim 4, wherein said encoding includes distributing the send energy able to be used to send the send vector in a predetermined number of individual send energy proportions, and distributing in a predetermined number of iterations in each case one send energy proportion to a selected one of the Q elements for which a lowest probability of incorrect decoding of the receive vector is produced.

6. A method as claimed in claim 3, wherein said encoding includes distributing the send energy able to be used to send the send vector in a predetermined number of individual send energy proportions, and distributing in a predetermined number of iterations in each case one send energy proportion to a selected one of the Q elements for which a lowest probability of incorrect decoding of the receive vector is produced.

7. A method as claimed in claim 2, wherein said sending uses Orthogonal Frequency Division Multiplex to send the send vector, so that the elements of the send vector are sent in each case by a carrier frequency.

8. A method as claimed in claim 7, wherein said encoding includes distributing the send energy able to be used to send the send vector in a predetermined number of individual send energy proportions, and distributing in a predetermined number of iterations in each case one send energy proportion to a selected one of the Q elements for which a lowest probability of incorrect decoding of the receive vector is produced.

9. A method as claimed in claim 2, wherein said encoding includes distributing the send energy able to be used to send the send vector in a predetermined number of individual send energy proportions, and distributing in a predetermined number of iterations in each case one send energy proportion to a selected one of the Q elements for which a lowest probability of incorrect decoding of the receive vector is produced.

10. A method as claimed in claim 1, wherein a radio communication system is used as the communication system and the send vector is sent over a wireless interface.

11. A method as claimed in claim 10, wherein said sending uses Orthogonal Frequency Division Multiplex to send the send vector, so that the elements of the send vector are sent in each case by a carrier frequency.

12. A method as claimed in claim 11, wherein said encoding includes distributing the energy able to be used to send the send vector in a predetermined number of individual send energy proportions, and distributing in a predetermined number of iterations in each case one send energy proportion to a selected one of the Q elements for which a lowest probability of incorrect decoding of the receive vector is produced.

13. A method as claimed in claim 1, wherein said sending uses Orthogonal Frequency Division Multiplex to send the send vector, so that the elements of the send vector are sent in each case by a carrier frequency.

14. A method as claimed in claim 13, wherein said encoding includes distributing the energy able to be used to send the send vector in a predetermined number of individual send energy proportions, and distributing in a predetermined number of iterations in each case one send energy proportion to a selected one of the Q elements for which a lowest probability of incorrect decoding of the receive vector is produced.

15. A method as claimed in claim 1, wherein said encoding includes distributing the energy able to be used to send the send vector in a predetermined number of individual send energy proportions, and distributing in a predetermined number of iterations in each case one send energy proportion to a selected one of the Q elements for which a lowest probability of incorrect decoding of the receive vector is produced.

16. A sending station in a communication system including a receiving station, comprising:
means for forming a send vector with an a-value modulation alphabet and Q elements from a data vector having N elements by coding with an error correction code, where a is a natural number greater than one;
means for distributing send energy, able to be used for sending the send vector, to the Q elements, taking into account at least one characteristic of the error correction code such that a probability of incorrect decoding of a receive vector, received by the receiving station and corresponding to the send vector, is reduced; and
means for sending the send vector to the receiving station.
